(19) United States
(12) Patent Application Publication
(10) Pub. No.: US 2013/0327244 A1
(43) Pub. Date: Dec. 12, 2013

(54) AUTONOMOUS MOVING HIGHWAY

(71) Applicants: Jeffrey C. Robbert, Wellington, FL (US); Matthew Bullivant, Jupiter, FL (US); Esther M. Rush, Fort Lauderdale, FL (US); Vipul C. Patel, Wilton Manors, FL (US)

(72) Inventors: Jeffrey C. Robbert, Wellington, FL (US); Matthew Bullivant, Jupiter, FL (US); Esther M. Rush, Fort Lauderdale, FL (US); Vipul C. Patel, Wilton Manors, FL (US)

(73) Assignee: Transit-21, Inc. (A Florida Corporation), Wellington, FL (US)

(21) Appl. No.: 13/493,388

(22) Filed: Jun. 11, 2012

(51) Int. Cl. B61B 13/08; B60L 13/04

(52) U.S. Cl. 104/281; 105/150

(57) ABSTRACT

An autonomous moving highway system including an elevated guideway having a support pier with a pier cap having a first end, a second end, an upper portion and a lower portion, where the lower portion of the pier cap is attached to the top end of the support pier, a first girder located at the first end of the pier cap and a second girder located at the second end of the pier cap, a first magnetically levitated (maglev) transportation track mounted to a bottom of the first girder and a second maglev transportation track mounted to a bottom of the second girder, a plurality of individual transportation pods, each transportation pod is configured to enclose a vehicle and at least one passenger of the vehicle, a computer control system configured to control power, propulsion, direction and motion of the plurality of transportation pods.

### BACKGROUND OF THE INVENTION

1. Field of the Invention

The field of the invention generally relates to a transit type system and more particularly to a transit type system that will transport people in their car on a computer controlled, elevated guide way.

2. Description of the Related Art

The existing surface transportation (roadway) system has three major failures: it is not safe, it is not reliable and it is not sustainable. In 2009, there were 81,599 crashes and 600 fatalities in south Florida (Palm Beach, Broward, and Miami-Dade Counties) alone. A 2008 NHTSA Crash Causation Survey has concluded that more than 95 percent of crashes are due to human error, and with the increase of distracted driving due to smart phones, these statistics are likely to become much worse. Surface transportation is over capacity at peak hours on most roads. Current long range plans attempt to keep up with population growth, but will not make significant improvements. Fossil fuels are a finite resource. Pollution problems come from drilling for oil, refining oil, carbon emissions, and the damage from runoff into the water system, loss of habitat, erosion, and the like.

Currently there are solutions for some of these problems, but no solution that resolves all of the issues. For example, one solution is to build new roads and/or add additional lanes to ease traffic woes; however, this will only increase environmental issues. More people driving results in higher numbers of fatalities. In addition, most major transportation corridors are already built out to the edge of available right of way, and thus adding lanes or creating new roads is a much more expensive proposition because high dollar land would need to be purchased for future lane expansion. Another potential solution is the increased use of hybrid, high mileage, and/or electric cars to ease some of the environmental concerns; however, such actions do nothing to reduce fatalities and/or traffic congestion. Electric cars also create new issues due to limited driving range capabilities as well as the requirements for battery disposal and charging stations.

Another potential solution is the use of self-driving cars. Self-driving cars will help with fatalities but only if everyone owns a self-driving car; otherwise distracted drivers remain a concern. Finally, transit systems, including bus/light rail and metro lines are the best solutions thus far as these transit systems help to reduce traffic congestion, fatality rates, and the environmental concerns; however, the increase in travel time and the requirement for transfers make these options of limited benefit. Furthermore, transit is only beneficial for people departing from and going to places within a few blocks of the track or bus route, which severely limits the usefulness to a large percentage of the population. Moreover, current transit systems are even less desirable during poor weather, whether it is rainy, humid, cold, or extremely hot.

### BRIEF SUMMARY OF THE INVENTION

Embodiments of the present invention address deficiencies of the art in respect to surface transportation systems and provide a novel and non-obvious system and method for providing an autonomous moving highway transit system that will transport people in their vehicle on a computer controlled, elevated guideway. In one embodiment of the invention, the autonomous moving highway system includes an elevated guideway having a support pier having a top end and a bottom end opposite the top end, a pier cap having a first end, a second end opposite the first end, an upper portion and a lower portion opposite the upper portion, the lower portion of the pier cap attached to the top end of the support pier, a first girder located at the first end of the pier cap and a second girder located at the second end of the pier cap, a first magnetically levitated (maglev) transportation track mounted to a bottom of the first girder and a second maglev transportation track mounted to a bottom of the second girder, a plurality of individual transportation pods; wherein each transportation pod is configured to enclose a vehicle and at least one passenger of the vehicle, a computer control system, the computer control system configured to control power, propulsion, direction and motion of the plurality of transportation pods and to automatically guide one of the plurality of transportation pods to a destination selected by a user, and a system station having a docking bay that includes a docking platform having a first end configured to receive the one of the plurality of transportation pod and a second end configured to receive the vehicle.

In one aspect of this embodiment, the computer control system comprises a plurality of command modules within each transportation pod configured to control power, propulsion, direction and motion of the plurality of transportation pods in a region of the guideway and to automatically guide one of the plurality of transportation pods to a destination selected by a user. In an aspect of this system, the autonomous moving highway system includes a track continuity module configured to process track emergencies that are identified by a track continuity sensor. In yet another aspect of this system, the autonomous moving highway system further includes an empty pod module configured to control flow of empty incoming and outgoing pods in the station and between stations.

In another embodiment of the invention, an individual transportation pod for use in an autonomous moving highway system that includes a pod body configured to enclose a vehicle and at least one passenger of the vehicle, a nose cone attached to a first end of the pod body and a pair of doors attached to a second end of the pod body that is opposite the first end of the pod body, a maglev sled attached to a top of the pod body, where the maglev sled is configured to engage with a maglev transportation track of an autonomous moving highway system, and a fail safe speed detector-emitter attached to a front surface of the maglev sled.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a perspective view of a transportation pod made in accordance with the present invention;

FIG. 2 is a rear perspective view of the transportation pod illustrating the back doors of the transportation pod are open to illustrate the interior of the transportation pod;

FIG. 3 is a front view of a corridor system made in accordance with one embodiment of the present invention;

FIG. 4 is a front perspective view of a track turnout made in accordance with one embodiment of the present invention;

FIG. 5 is a rear perspective view of a track turnout made in accordance with the present invention;

FIG. 6 is a side perspective view of docking bay at a station and made in accordance with the present invention;

FIG. 7 is a top perspective view of another corridor alignment and made in accordance with the present invention;

FIG. 8 is a top perspective view of a station and made in accordance with the present invention; and

FIG. 9 is a block diagram of the control system of the autonomous moving highway transportation system made in accordance with the present invention.

### DETAILED DESCRIPTION OF THE INVENTION

The autonomous moving highway is a transit type system that will transport people inside their personal vehicle quickly, safely, and without gas on a computer controlled, elevated guideway. The highway portion of the daily commute changes from being stuck in traffic to a relaxing ride, sitting back in the user's own vehicle, while traveling at speeds greater than 200 mph. One advantageous feature of the autonomous moving highway is that users remain in their own vehicle the entire time and thus there are no transfers, no unusual people to address and no waiting. Any automobile (even a full size pick-up truck, SUV, or van) can fit in the transportation pod, which has a magnetic levitation (maglev) sled mounted above the roof. The maglev sled connects into an overhead track system consisting of an energized track that will propel, guide, and control the pods. The maglev system operates independently of the user's vehicle engine. The track will have entrances and exits at various stations, but unlike a traditional subway or train, there is no need for all transportation pods to stop when one user needs to exit the system. The transportation pods keep moving at full speed. Users will drive on regular streets to the moving highway entrance; then the system will transport them to another station where they exit onto the surface street as a normal automobile. By using the same vehicle on/off system, users will not be limited by the location of the track. Even users who do not live or work near the track can benefit for a portion of their trip and/or daily commute.

In embodiments, the autonomous moving highway system includes an elevated guideway having a support pier having a top end and a bottom end opposite the top end, a pier cap having a first end, a second end opposite the first end, an upper portion and a lower portion opposite the upper portion, the lower portion of the pier cap attached to the top end of the support pier, a first girder located at the first end of the pier cap and a second girder located at the second end of the pier cap, a first magnetically levitated (maglev) transportation track mounted to a bottom of the first girder and a second maglev transportation track mounted to a bottom of the second girder, a plurality of individual transportation pods; wherein each transportation pod is configured to enclose a vehicle and at least one passenger of the vehicle, a computer control system, the computer control system configured to control power, propulsion, direction and motion of the plurality of transportation pods and to automatically guide one of the plurality of transportation pods to a destination selected by a user, and a system station having a docking bay that includes a docking platform having a first end configured to receive the one of the plurality of transportation pod and a second end configured to receive the vehicle.

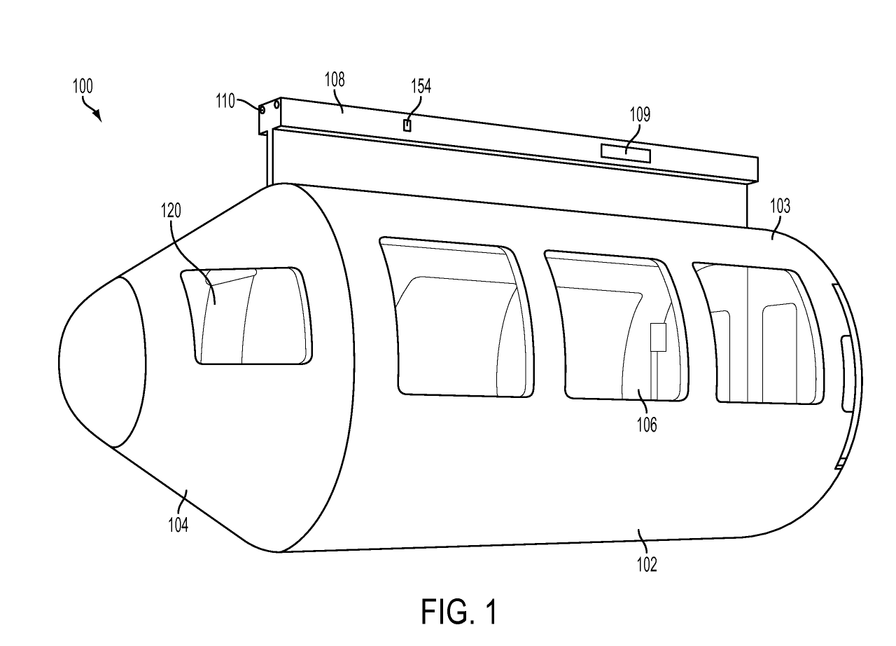

In illustration, FIG. 1 depicts a transportation pod 100. As shown in FIG. 1, a transportation pod 100 can include an aerodynamic body 102 and an aerodynamic nose cone 104. The body 102 can include one or more windows 106, while the nose cone 104 can include one or more windows 120. Windows 106 and 120 can be electronically blacked out via controls on a user interface keypad to minimize any user visual discomfort from high speed travel. A central computer user database 966 can save user preferences based on identification through vehicle RFID Tags to black out windows based on speed or distance from stations. The body 102 is designed for structural integrity and strength as well as aerodynamic efficiency, similar to an airplane fuselage and defines a pod interior 101. In embodiments, the pod interior 101 can be sized to fit a 15-person passenger van, a full size pick up truck, a large off-road vehicle and a truck with a wider rear end, sometimes referred to as a “dualie” (for example, a vehicle that has a width of up to 10 feet, a height of up to 7 feet 10 inches and a length of up to 21 feet).

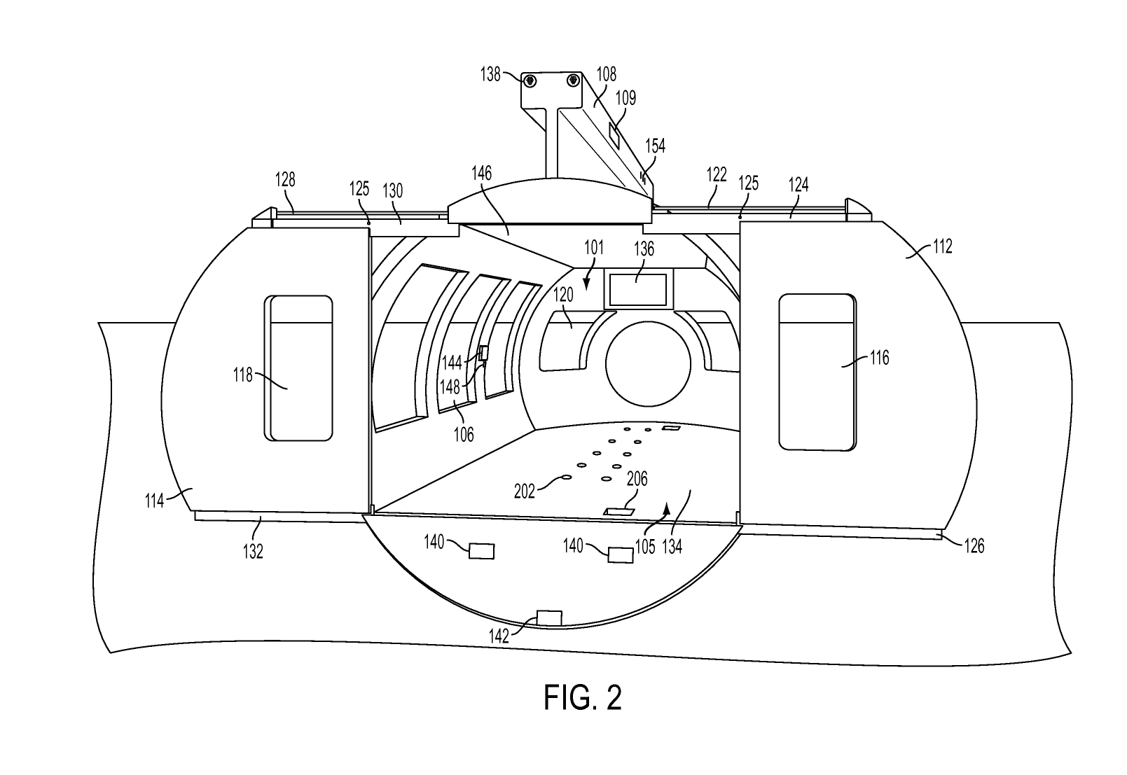

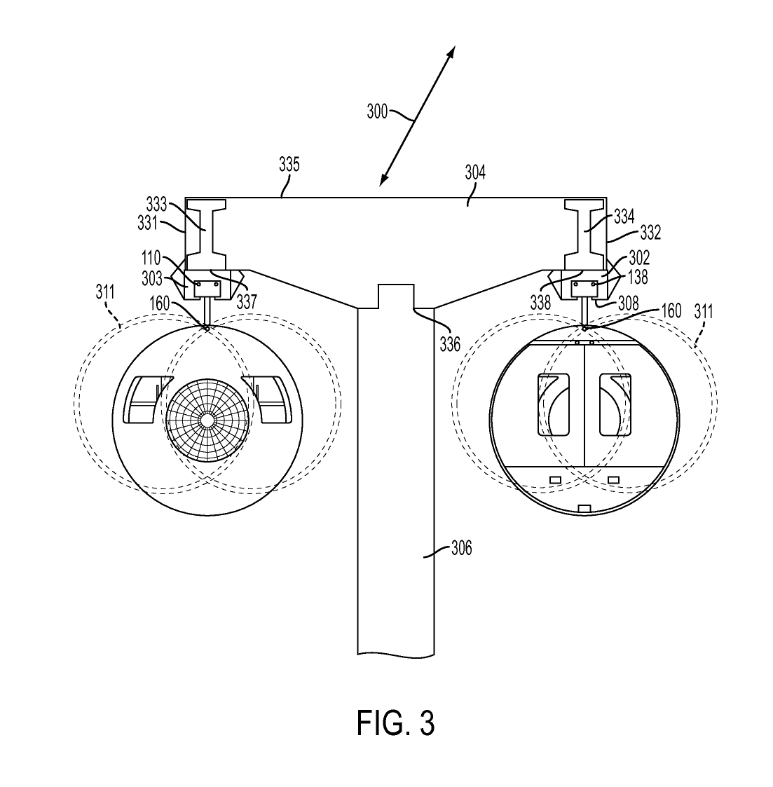

The pod 100 can include a maglev sled 108 mounted above the roof 103 of pod body 102. As illustrated in FIG. 2, maglev sled 108 can be T-shaped and provide secure connection of pod 100 to maglev track 302. Overhang arms 308 attached to maglev track 302, 303 will catch and hold the maglev sled in event of a maglev failure. Pod 100 is suspended from above for operation in all weather, regardless of snow accumulation, rain, and/or fog, including up to medium or high winds. The maglev components are contained within the sled 108 and provide lift, propulsion and braking, and are based on existing available electromagnetic suspension (EMS) technology. Although in this embodiment, the movement of the pod 100 is propelled by maglev technology, other technology could be used to propel the pod 100 on the tracks, for example a wheeled propulsion unit could be used. The bottom of T-shaped maglev sled 108 extends into top 103 of pod body 102 and is connected by a pivot hinge 160, (see FIG. 3). Pivot hinge 160 is connected between pod body 102 and sled 108. Although track super-elevation is designed to account for all super-elevation required, the pivot hinge 160 allows the pod 100 to swing to natural angle when actual pod speed differs from track design speed. In addition, pivot hinge 160 will allow the pod 100 to level out if stopped in super-elevated track section and provides up to 30 degrees of motion between pod 100 and sled 108. In one embodiment, pivot hinge 160 is a continuous steel rod (e.g., one and a half inch diameter), which will typically extend for the entire length of sled 108.

As illustrated in FIG. 2, pod body 102 can further include sliding rear doors 112, 114 which provide up to ten feet of width clearance for vehicles entering and exiting the pod 100. Rigid sliders 124, 126, 130 and 132 provide rigid support for the entire width of the door when closed. Thus, even if a vehicle were to back up into the doors, the doors would not yield. In addition, two pneumatic pistons 122, 128, one for each door 112, 114 open and close the doors in a single motion. As an additional safety mechanism, there is a shear pin 125 that intersects rigid sliders 124, 130 which will not retract unless pod 100 is properly docked at a docking station 320. Rear doors 112, 114 can include at least one window 116, 118. Pod body 102 can further include floor 105 opposite the top 103 of pod body 102 and the floor 105 can have a high friction surface 134 which is an epoxy surface that creates a very high coefficient of friction between surface 134 and vehicle 1050, even when wet. As such, high friction surface 134 will ensure that the vehicle 1050 does not move during pod motion. Longitudinal acceleration and deceleration will be limited to less than one third of gravity, which represents the highest rate before general user discomfort, and is far less than the deceleration during normal driving. Even a vehicle 1050 with worn tires will have sufficient friction to remain stationary within the pod 100. Track alignment and super-elevation eliminate force of all lateral acceleration, thus the vehicle 1050 will be secure based only on friction between tires and pod floor 105 with high friction surface 134.

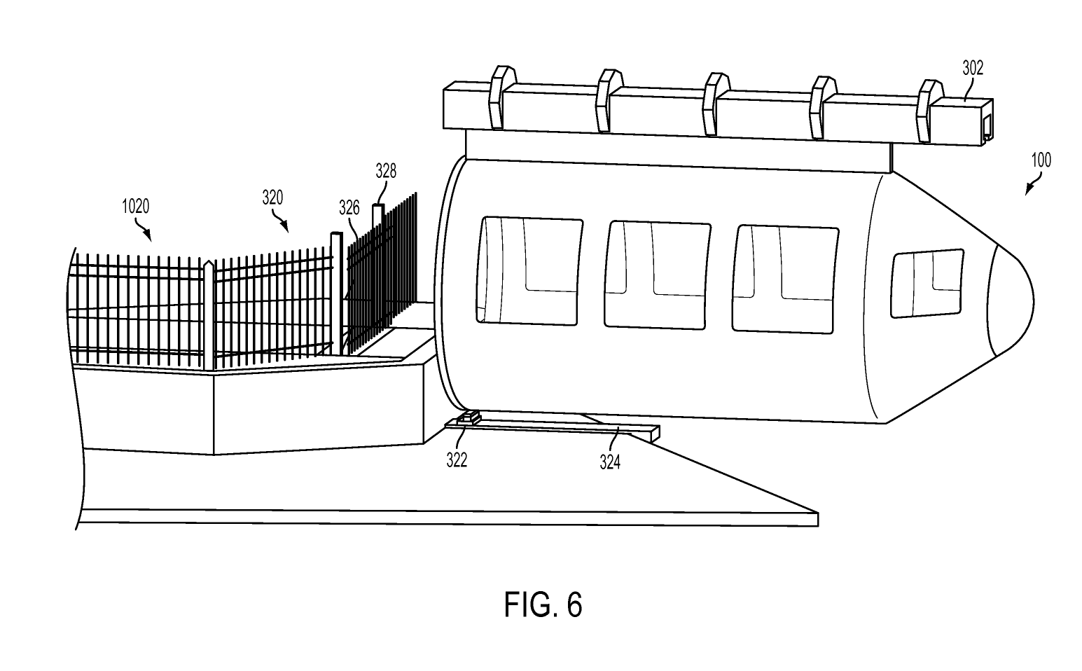

As illustrated in FIG. 2, pod body 102 can further include a front display screen 136, which provides guidance and instruction during loading and unloading of a pod 100. For example, the front display screen 136 can display green, yellow, and red colors to aid a driver during entrance and exit of the pod 100. Also, front display screen 136 can display instructions to turn off or on the vehicle's engine and other information or instructions during trip. For example, other information can include travel time to destination and periodic advertisements. Pod body 102 can further include dock stabilization magnets 140, which hold the pod 100 in place during loading and unloading. When a vehicle 1050 enters the pod 100 and brakes, the deceleration force of the vehicle 1050 will create an equal and opposite acceleration force on the pod 100. In order to maintain the pod 100 stationary, the dock stabilization magnets 140 will be of sufficient strength to resist the forces on the pod 100. Pod body 102 can further include a back-up trolley magnet 142 located near the bottom of the back of pod 100. The back-up trolley magnet 142 is designed to connect to a back-up trolley 322 (shown in FIG. 6) for pod 100 to maneuver back into dock 320 (shown in FIG. 6).

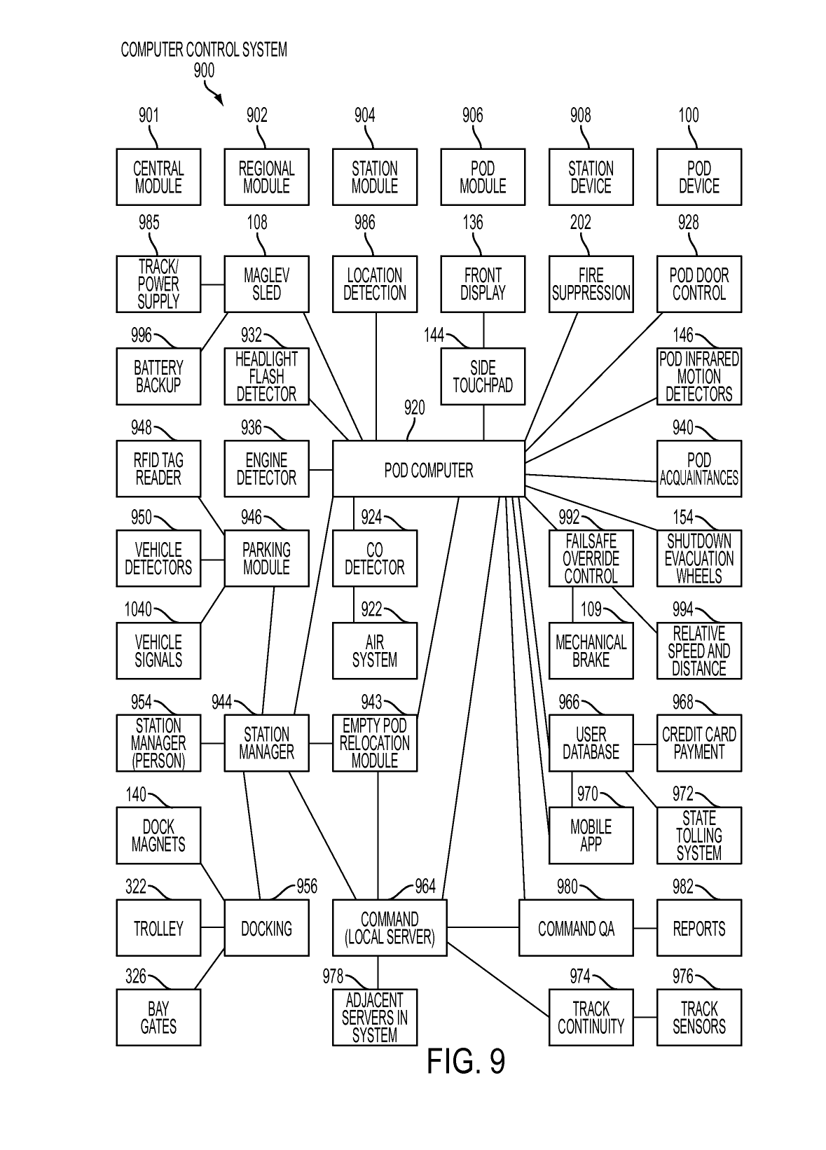

As illustrated in FIGS. 2 and 9, pod 100 further can include a pod air conditioner 922 and carbon monoxide detector 924 that connects to air conditioner system vents 206. When the engine of the vehicle 1050 is turned off, the pod doors 112, 114 will close and the entire pod interior 101 can be air conditioned, with air exchange 922. For user comfort, the pod can be heated (e.g., to 70 degrees) and/or air conditioned (e.g., to 78 degrees). To ensure user safety, air exchange 922 will keep air safe from carbon monoxide. Even though users are instructed to turn off engines, a fail safe system is designed assuming that the engines are not turned off. Carbon monoxide detectors 924 will cause an alarm noise and flashing signals on the screen 136 directing the user to turn off the engine. The air exchange 922 will go into high speed. By use of air exchange 922, pod air conditioner is not trying to work against heat from engine. Heat from the engine of the vehicle is dissipated and carried away by air exchange. Pod air conditioner heats or cools outside air temperature and humidity to comfortable level. Pod 100 further can include a set of infrared vehicle location beams 146, which can alert the user when the vehicle is completely within the pod, as pod doors 112, 114 will not close until the vehicle 1050 is completely within pod 100. In addition, the set of infrared vehicle location beams 146 will monitor car movement during trip. Pod 100 further can include an emergency fire suppression system 202, which can be a foam system contained in floor 105 of pod, will extinguish any user car engine fire from underneath the vehicle 1050.

As illustrated in FIG. 2, pod 100 further can include a user interface keypad 144 (e.g., a side touchpad), which functions as the main control interface for users. When entering pod, user interface keypad 144 screen can display the same instructions as front display screen 136. When the vehicle engine turns off and pod doors close, a screen of user interface keypad 144 and front display screen 136 can display information, such as the top 5 destinations based on time and location. The top 5 destinations can be based on the specific vehicle that entered the pod. Destination history is stored in central computer user database 966 for each vehicle based on the vehicle's RFID transponder. Pod 100 can depart immediately to number 1 destination, and user can change destination as desired even while the pod is in motion. If a destination history is not available, the pod can depart in the default direction for that station, the user will need to input a destination or the pod can stop at the next station and alert the station manager. Destinations can be selected from list menu, map view, or by typing address and letting system determine best station. User interface keypad 144 screen will display a navigation screen with location, time, arrival time, and travel speed. At all times during travel, there is a red stop icon that will take pod to closest upcoming station. Users can also edit preferences for default destinations, opaque windows, pod lighting, and review other account information and history. Pod 100 further can include a fail safe battery backup 996. In unlikely event of system power failure, each pod has enough battery power to convey pod to closest station. The level of battery backup will vary based on the largest spacing between stations for each particular transit system. As speeds decrease, the power demand per mile decreases such that in emergency events such as this, speeds may decrease to normal highway speeds, but the pods will make it to a station. Computer control system 900, via track continuity module 974 and track continuity sensors 976, identifies track sections with power outages or failures and automatically redirects all impacted pods to nearest station. All central computer modules 901, regional computer modules 902, station modules 906 and network switching locations have battery backup as well to ensure communication is maintained. Pod 100 further can include power ports 148 that can be located adjacent to the user interface keypad 144. Users can plug in devices or connect a cord to plug into a vehicle lighter jack. In event of maglev failure in track 302, each pod 100 will have shutdown evacuation drive wheels 154 that can extend out from the maglev sled 108. These drive wheels 154 will only be deployed if the system is at a total standstill and tracks need to be evacuated. Drive wheels 154 can be controlled remotely by manual operator. Drive wheels 154 will move pod forward or backward as needed to nearest station

Pod 100 further can include a fail safe override control 992, which can include a speed detector emitter/receiver 110 that is located at front of the maglev sled 108. Fail safe override control 992 looks ahead to verify emergency stopping distance and speed of forward pods. Each pod 100 also has a reflector 138 on the rear of maglev sled 108 (see FIG. 2). Each failsafe override control 992 can override pod computer 902 if the pod 100 is approaching a forward pod faster than that forward pod is traveling and a collision is eminent. The eminent collision is communicated to the following pods and regional command computer 964 as well. In emergency, failsafe override control 992 can trigger a mechanical brake 109. The mechanical brake 109 is a single use brake pad that when triggered, will eject from the side of the sled 108 and wedge itself between the sled 108 and inside of the maglev track 302.

As illustrated in FIG. 3, corridor 300 can include two parallel girders 333, 334 one in each direction, mounted to a support pier 306 and pier cap 304. The pier cap 304 can have a first end 331, a second end 332 opposite the first end 331, an upper portion 335 and a lower portion 336 opposite the upper portion 335, the lower portion 336 of the pier cap attached to the top end of the support pier 306. The girders 333, 334 are used to support maglev tracks 302, 303, which are connected to the bottoms 337, 338 of girders 333, 334. Support pier 306, pier cap 304, and girders 333, 334 are per local construction standards. Each of the maglev tracks 302, 303 is a single direction track to create the safest possible system by eliminating any risk of head-on collision between pods 100. Minimum spacing between tracks 302, 303 in tangent sections of corridor 300 can be 20 feet on center; although the spacing may need to be increased to allow for the width of support pier 306. The distance of 20 feet is based on the pod diameter of 12 feet 4 inches and allows the pods 100 to swing 30 degrees 311 off center without obstruction. In curved sections of corridor 300, the total distance between tracks 302, 303 can remain the same though the support piers 306 would not be centered between tracks 302, 303. In general, track curvature is designed based on existing constraints such as following highway alignment or staying within existing public right of way. Angle of super-elevation (i.e., tilt) is based on track curvature and velocity. With proper super-elevation, the effect of lateral acceleration can be eliminated thus providing maximum comfort for users and allowing vehicles to remain stationary in pod despite curves. If actual pod speed is higher or lower than design speed for track curvature, the pod pivot hinge 160 can make up the difference to eliminate the feel of lateral acceleration. Maximum super-elevation angle can be 45 degrees before users would feel additional normal force. 30 degrees represents factor of safety and reasonableness of track design with respect to user acceptance. Maximum track speed is based on alignment curvature. In order to follow existing highway alignment track velocities may be decreased in curves. Pivot hinge 160 in pod 100 will allow for larger super-elevation angle, beyond track super, although the general intent is to have the pod 100 and sled 108 normal to the track 302, 303. Minimum vertical clearance between bottom of pod 100 and existing ground or roadways will be per local standards; however, an absolute minimum of 17 feet is expected. With this elevation, even if a large truck were to pass beneath the pod 100, there should be no conflict. Wherever the track 302, 303 crosses a roadway with less than 20 feet clearance to the bottom of the pod 100, a canopy structure can be constructed below the pod 100 limits to ensure that nothing fouls the airspace for the pod 100, be the vehicle a large truck or crane.

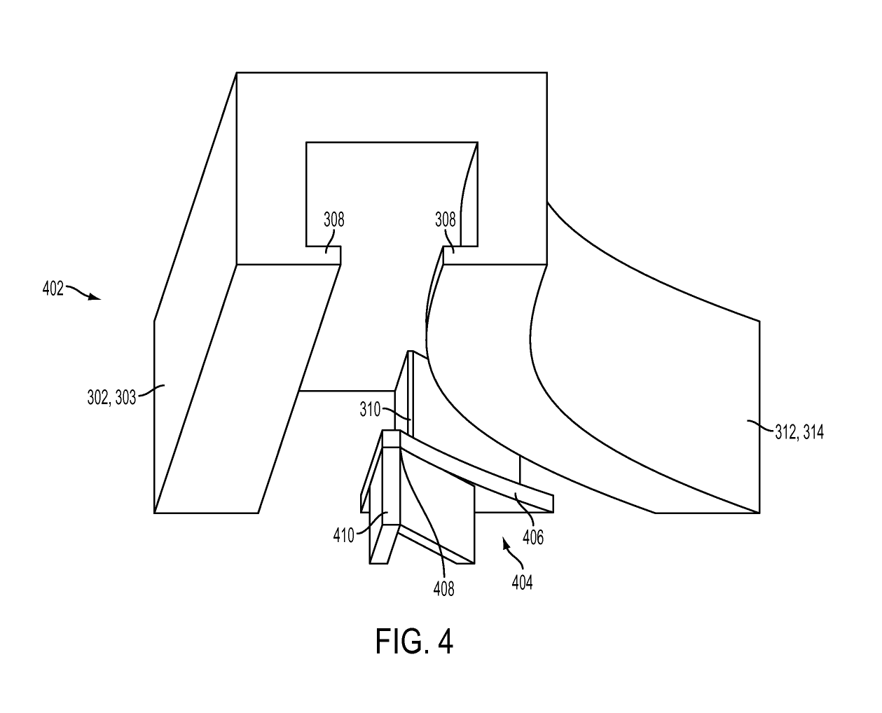

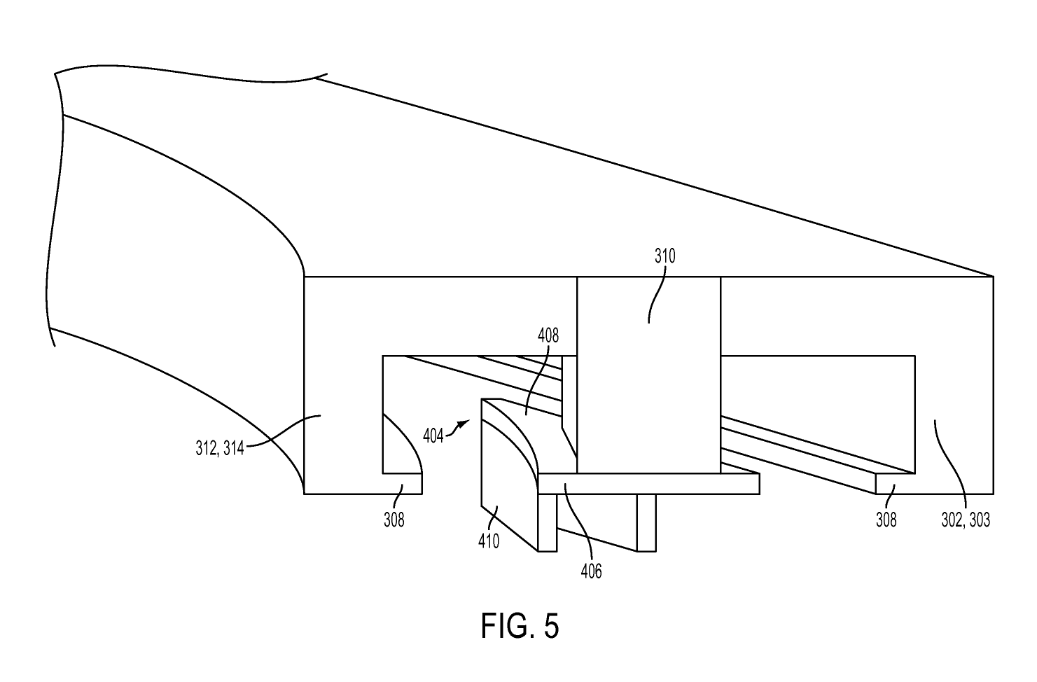

As shown in FIGS. 4 and 5, high speed spiral turnouts 402 have no moving parts at switch. Instead, an attractive force within the maglev sled 108 will hold a pod 100 to either stay on mainline track 302, 303 or to switch to exit track 314. Holding the left side of the track 302 will cause the pod to stay on the mainline track 302, holding the right side will cause the pod to go to exit track 314. Turnout 402 length is based on track design speed and turnout spiral. Exit track 314 has no additional super-elevation beyond mainline track 302, 303, lateral acceleration through exit track 314 is absorbed by pivot hinge 160 of pod 100, and thus pod 100 is super-elevated more than track 314 through turnout 402. Design pod super-elevation though turnout 402 is approximately 4 percent. As shown in FIGS. 4 and 5, turnouts 402 are located where the mainline tracks 302, 303 split (and/or merge). Turnouts 402 include overhang arms 404 that appear in the middle of the turnout 402. Overhang arms 404 include center overhang arms 406 supported directly from the center support 310, and cantilever overhang arms 408. The center overhang arms 408 cannot be supported from above for a certain length due to the width of the maglev sled 108, thus creating a cantilever situation. The cantilever overhang arms 408 are the extension of the center overhang arms 406 that are not directly supported by the center support 310. The length of the cantilever overhang arm 408 is based on the curvature of the turnout, which is approximately 52 feet for 200 mph. A vertical support 410 can be added to the cantilever overhang arm 408 to create the strength required for the large distance. The vertical support 410 extends the entire length of the cantilever overhang arms 408 and sufficient length of the center overhang arms 406 to develop strength to support the cantilever arm 408.

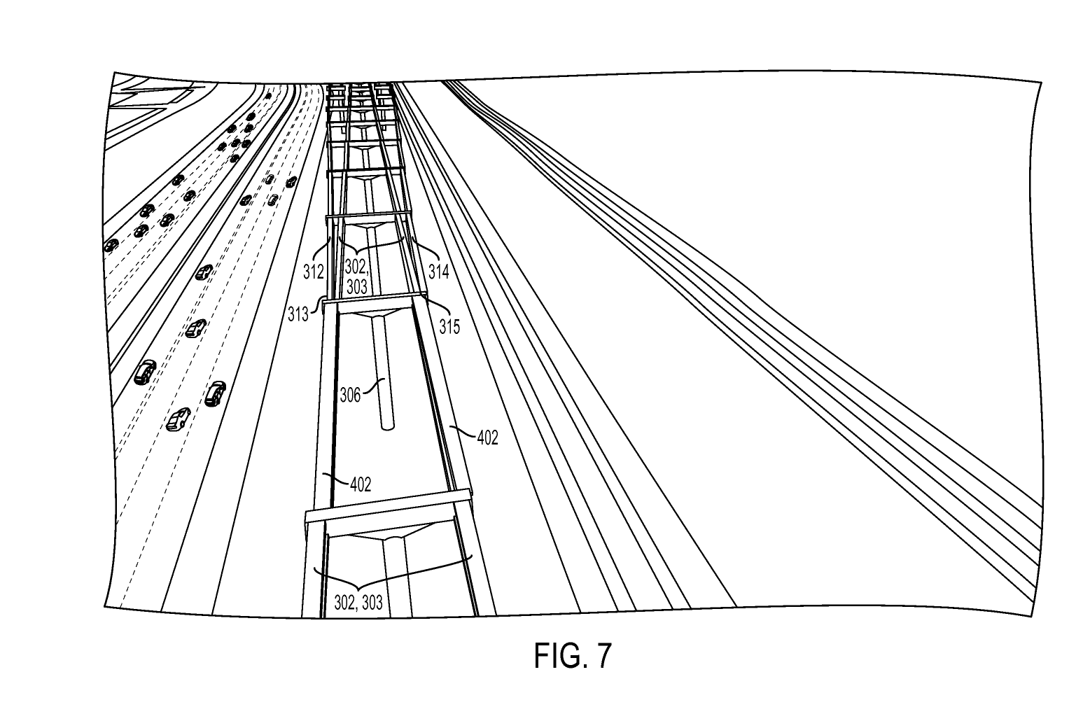

As shown in FIG. 7, track alignment can generally follow existing highway alignment, but may need some shift to create longer spirals in curve transitions. Turnout arrangement can be designed to have all support piers 306 in a single line, such as along highway median or median barrier. Turnout splits 314 exit track 303 at the same elevation as mainline track 303. When exit track 314 is 12 feet from mainline track 303, exit track 314 may commence to increase elevation until exit track 314 is 22 feet above mainline track 303, where the 22 feet vertical separation is based on pod height, sled, track, and structure depth. When vertical separation is attained, the exit track 314 curves back toward the mainline track 303 until it is directly above. Deceleration can begin once the exit track 314 is 12 feet beyond the mainline track 303, at this distance; the mainline track 303 pods are not impacted by the slower exiting 314 pods. Because the deceleration ramps are completely in line with the mainline track 303, the exit track 314 can attain a much lower speed, and tighter curvature, thus fitting within the existing interstate right of way, even without additional right of way width at the interchange. Similarly but in a reverse manner, the entrance merge 312 enter the track at the same elevation as mainline track 302.

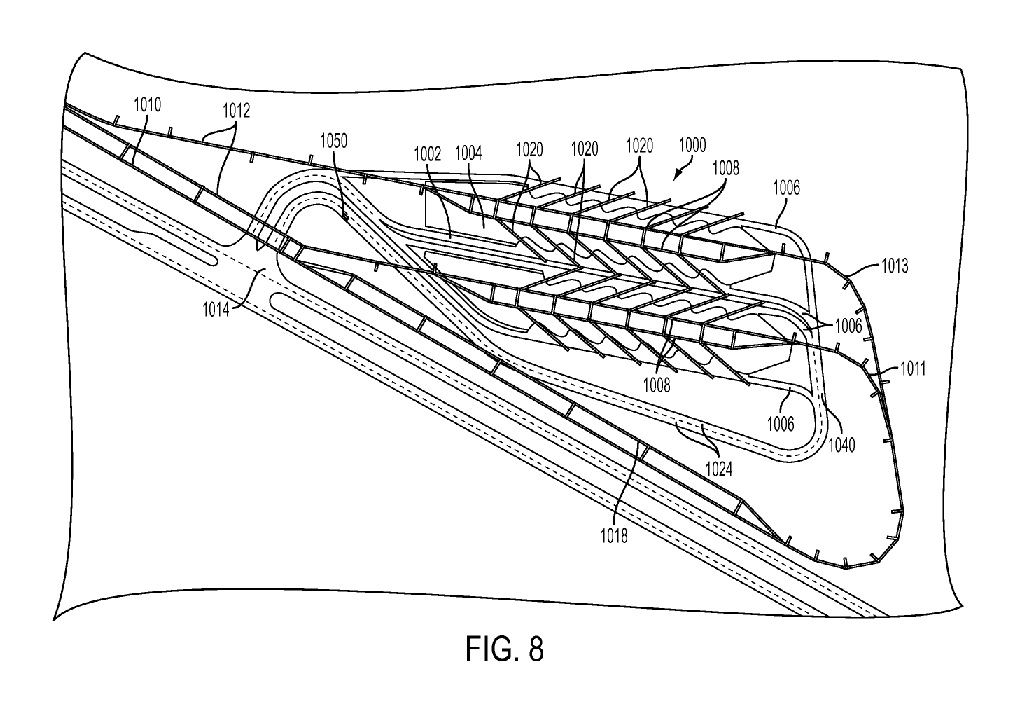

As illustrated in FIGS. 6 and 8, a station 1000 can include vehicle areas 1002 and pod areas 1004. In general, to avoid conflicts, pods 100 and vehicles 1050 never cross areas. Pods 100 enter the station 1000 on elevated track 1010 which can split into two lanes 1011, 1013 and descend to ground level. Each lane 1011, 1013 can in turn divide into two pod lanes 1008 for a total of four pod lanes 1008. In other embodiments more or less pod lanes 1008 can be provided depending on the traffic demands of the station. Multiple docking bays 1020 on each lane 1008 create area for vehicles 1050 to drive, at level grade, directly into a pod 100. Each docking bay 1020 can be 65 feet apart, which provides distance for the pods 100 to stop and back up at the same time without hitting each other. As illustrated in FIG. 8, each pod lane 1008 has 6 docking bays 1020; however, the number of docking bays 1020 per lane 1008 is based on flow time for each vehicle 1050 to enter and egress, specifically time for pod 100 to enter station lane 1008, back into docking bay 1020, rear doors 112, 114 open, vehicle to start engine, back up drive off, next vehicle 1050 to enter, rear doors close, pod 100 exits docking bay 1020 to pod lane 1008 and merges into station exit track 1012 toward mainline track 302, 303. Spacing between docking bays 1020 allows for multiple vehicles 1050 to enter or exit in quick succession. Vehicles 1050 enter station 1000 from roadway at entrance 1014. The entrance 1014 widens to channel lanes 1024, one channel lane 1024 per pair of vehicle lanes 1006. Vehicles 1050 are directed by signal 1040 to appropriate vehicle lane 1006. Vehicles 1050 drive through docking platform 320 into pod 100. From the driver's perspective, entering the docking platform 320 is the same as pulling into a parking spot. A pair of pod lanes 1008 with six bays 1020 on each side has a capacity of processing approximately 425 vehicles per hour. In this embodiment, pods 100 enter the pod lanes 1008 at an average of eight second intervals, and go to the last available docking bay 1020. When the pod 100 is docked at the docking platform 320 of the docking bay 1020, the doors open, the vehicle 1050 starts its engine and backs up. After all pods 100 in that pod lane 1008 have emptied, new vehicles 1050 enter the associated vehicle lane 1006 and begin filling the pods 100. With pod lanes 1008 based in sets of pairs, one pod lane 1008 is generally loading vehicles 1050 while the other pod lane 1008 is unloading vehicles 1050, thus avoiding vehicle and/or pod weaving. As soon as a pod 100 is filled and the vehicle engine is turned off, doors close and the pod 100 will depart. When the last pod 100 departs from each pod lane 1008, a new pod 100 will enter to drop off a vehicle 1050. The time spacing is balanced such that the flow of pods 100 or vehicles 1050 is not interrupted.

Pod lane 1008 configuration includes a track with a reverse turnout for each docking bay 1020, all to one side. The reverse turnouts allow the pod 100 to back into each bay 1020. For safety reasons, the maglev sleds 108 are not capable of going in reverse. As such, the pods 100 need external devices to back up into the docking bay 1020. Back up trolleys 322 are located at each docking bay 1020 and serve to retrieve a pod 100 that is stopped on station pod lane 1008 and bring the pod 100 backward to the docking bay 1020. The pod 100 remains attached to the maglev track, continuing to use maglev for levitation, and will use the maglev propulsion to depart from the docking bay 1020. The back up trolley 322 is a ground mounted track 324 on the same alignment as the overhead track. The back up trolley 322 generally fits below the pod, except for a thin vertical plate that can attach to the back of the pod 100 via the trolley magnet 142. When pod 100 departs, the back up trolley 322 stays in place at the bay docking platform 320 until the next pod 100 needs to be retrieved from the pod lane 1008. Back up trolley track 322 is single vertical guide-way track 324. The back up trolley 322 fits over vertical guide-way track 324 and has electric drive wheels that also contact guide-way track 324. Power for the motor is positive and negative drag line on either side of guide-way track 324. The station docking computer 956 controls the back up trolleys 322. Docking bay gates 326 are located at the end of each platform 320 and open in conjunction with the pod doors 112, 114 and serve to keep waiting vehicles 1050 at the appropriate distance to allow pod doors 112, 114 to open. Docking bay gates 326 also ensure that vehicles 1050 do not drive off the edge of the docking platform 320 when a pod 100 is not present. Gate posts 328 line up with pod opening to keep vehicles 1050 centered and generally protect pod 100 from vehicles 1050. Docking bay gates 326 are connected to perimeter fence around pod area 1004 Once the back up trolley 322 brings a pod 100 backward to the docking wall of bay 1020, docking bay gates 326 can open to allow the egress of a vehicle 1050 from the pod 100. Storage tracks 1018 for empty pods 100 ensure that a steady supply of pods 100 is available during peak usage periods. Empty pod relocation module 943 communicates with local server 964 and tells empty pods 100 when and where to relocate.

During normal operation of a station 1000, the standard procedure is for all docking bays 1020 to have an empty pod 100 waiting for a new vehicle 1050 to enter. Waiting pods will have doors closed until the empty pods 100 are ready to be loaded to prevent excess wind, rain and debris for entering into a pod 100. For each station 1000, in flow and out flow must be equal, regardless if pods 100 are occupied or empty. If all docking bays 1020 have pods 100 and an occupied pod 100 enters the station 1000, an empty pod 100 will depart. In peak flow times, when stations are heavily skewed toward all arrivals or all departures, empty pods 100 will travel from arrival stations 1000 to departure stations 1000. Each station 1000 will have a section of storage track 1018 to hold empty pods 100 to create a buffer, such that exact timing of empty pod arrivals does not create user delays. When an occupied pod 100 departs, a pod 100 needs to enter the station. If an occupied pod 100 is on its way, and will arrive soon, then no other action is needed. If the station 1000 has significantly more departures than arrivals, an empty pod 100 will arrive to fill the empty docking bay 1020. The empty pod relocation module 943 has perfect information such that incoming empty pods 100 can be on their way prior to actual need. Storage tracks 1018 create a surplus of available pods 100 such that users will not have to wait. Roadway traffic signals 1040 will communicate to vehicles 1050 and direct vehicles 1050 to the appropriate lane 1006 and platform 320 to create smooth flow of incoming vehicles 1050, thus reducing weaving of arriving and departing vehicles 1050 on the same lane 1006. Overhead lane signals 1040 can alert drivers to any lane closures, such as during non-peak times.

Prior to the channel lane 1024 fork to the pair of vehicle lanes 1006, there can be a six head traffic signal 1040 on a mast arm pole. The traffic signal 1040 will direct vehicles 1050 to either go straight or turn left. Vehicle detectors 950 will count vehicles and with one remaining open pod, the signal may turn yellow. After a vehicle 1050 enters the vehicle lane 1006 to fill the last open pod 100, that signal 1040 can turn red and direct vehicles 1050 to the other direction in the fork. Vehicle detectors 950 at the beginning and end of the pod lane 1008, together with knowledge of vehicles 1050 entering and exiting pods 100, will keep a running tally of the number of vehicles 1050 in the vehicle lane 1006. This running tally is the number of vehicles 1050 that the signal 1040 will count up to and allow into each vehicle lane 1006. If a vehicle 1050 runs the signal or a vehicle 1050 does not exit a pod 100, the system will self-correct and reduce the number of new vehicles 1050 entering that vehicle lane 1006.

Vehicles can have a RFID sticker (e.g., can be same as local toll system) to identify vehicle. A RFID reader 948 is located on platform 320. User database 966 identifies the vehicle 1050 and top five destinations based on entry time and location. Vehicle 1050 enters empty pod 100, sets vehicle gear to park and/or apply parking brake, and turns off the engine. Pod doors 112, 114 close upon engine shut off. As pod motion commences with the pod traveling towards the primary destination, user can choose other destination at any time, but primary destination is the default so that for regular users, no input is required. For example, when a vehicle 1050 enters the system on a weekday morning, the default will be the station 1000 near the user's office, similarly, in the evening; the system can default to take the vehicle 1050 to the station 1000 near the user's home. Pod interior 101 can include a headlight flash detector 932 that provides an interface to receive signals created by flashing hi-beam headlights of the vehicle 1050. When the top five destinations are shown, users can scroll through the list by flashing hi-beam headlights, which allows users to change initial destination without opening a window to access the side touchpad 144 or using a mobile phone application 970. Users also can edit default or pre-select destinations through a website or a mobile application 970.

Constant two way communication between pod computers 920 and local servers 964 includes an independent communication system, which is not part of the Internet. Computer control system 900 as a whole has perfect knowledge of all track continuity 974 and pods 100 and dictates position and speed of all pods 100 with no user input. When a new pod 100 enters the system all projected positions and speeds are adjusted to allow for merging and proper pod spacing. Computer control system 900 includes central modules 901 e.g., such as modules that only require one per state, user database 966, mobile application 970. The user database 966 can also connect to credit card payment system 968 and state tolling system 972. Regional modules 902 such as one or more per county or sub area can include, command local server 964, track continuity module 974, Command QA module 980, and empty pod relocation module 943. Station modules 904 include, station manager module 944, docking module 956, parking module 946. Pod modules 906 can include pod computer 920, pod acquaintances module 940, and failsafe override control 992. Pod computer 920 interfaces with all devices in pod 100, such as air system 922, carbon monoxide detector 924, front display 136, pod door control 928, fire suppression 202, headlight flash detector 932, pod infrared detectors 146, side touch pad 144 and engine detector 936. The pod acquaintance module 940 contains a list of all the other pods 100, which a pod 100 will either lead or follow during that pod's journey. Depending on system size and overall distance, there can be multiple regional computers 964, 978 to reduce latency in commands to each pod computer 920. General pod motion is dictated by each individual pod computer 920. Station manager module 944 tells pod computer 920 which lane and bay to go to within the station 1000, as well as vehicle signals 1040 back up trolley 322 and bay gates 326.

All programming modules will be events based. The registering components (servers 964 or pod computers 920) will have delegates set up to receive event notification. This will guarantee that the system is in harmony without overcrowding the network. The communication is between components that need to communicate and not a broadcast model which sends out packets of information on the network to all listeners. All servers 964 are aware of the location of all pods 100. Each pod computer 920 will interface with the local server (Command) 964. Each Local Server 964 will have a regional (geographic) zone. Pod computers 920 will know the credentials of the next local server 964 based on the direction and current location. When a pod computer 920 registers with a local server 964, that server, based on the direction and current location, will identify the next local server 978 for the pod 100 in the return message. When a pod computer 920 registers with a local server 964, the local server 964 will then propagate the information to all the servers 964, 978 in the system. These local servers 964 will act as backup servers for each other. The local server 964 can monitor the pods 100 for distance and speed by the Command QA module 980. Any necessary corrections to distance and speed will be communicated to the pod computers 920. Emergencies, such as pod failure or track blockage will be identified by the Track Continuity module 974 is monitored by the servers 964, 978, which provide notifications to the pods 100. Transit system includes a single direction track, merges 313, and forks 315. Merges 313 include a mainline track 302, 303 (on the left) and an on-ramp track 312 (from the right). Forks 315 include a mainline track 302, 303 (to the left) and an off-ramp track 314 (to the right).

Pod computers 920 have knowledge of the other pods 100 immediately preceding and succeeding it as well as those projected to be preceding or succeeding for the duration of the trip 940. This knowledge includes current position and speed and projected time and speed at merge points. As routes for all pods 100 are known, pod computers 920 can project when they will be at a merge point, thus the pods' computers 920 will also know any projected preceding and succeeding pods 100 from each merge point. These immediately preceding and succeeding pods along with any projected preceding and succeeding pods make up the group of acquaintances 940 for each pod. Each pod computer 920 will have its own group of acquaintances 940. When a pod first leaves the station 1000 (enters the system) or changes destination, the local server 964 will create that pods' initial group of acquaintances 940. The pod computer 920 will notify the other acquaintance 940 pods.

Standard operating procedure is for equal sharing of speed deflections for on-ramp pod 923 and mainline pod 921. Both the on-ramp pod 923 and the mainline pod 921 adjust speed as needed to create single mainline stream of pods 100. The minimum time spacing for following pods is 0.1 seconds and the minimum time spacing between mainline pods 921 for an on-ramp pod 923 to merge in is 0.5 seconds. As on-ramp pod 923 approaches the merge, on-ramp pod 923 is in communication with projected preceding and succeeding mainline pods 921. This preceding and succeeding mainline pair of pods 921 know that on-ramp pod 923 is coming and will create spacing by slightly accelerating or decelerating for on-ramp pod 923 to merge in. The default operation is for mainline pods 921 to accelerate and create space for the on-ramp pod 923. Because pods 100 communicate with pods 100 in front of them, multiple pods in close spacing can all accelerate in unison to make room, even if pod 100 is well past the merge. This operation applies to all merge points. If pods are in close spacing on both approaches, the pods 921, 923 will come together e.g., in a zipper-like manner. In these situations, with heavy flows from both sides, the pods 921, 923 on each approach can also double or triple up through the merge. Pods 921, 923 will plan to increase spacing just before the merge. Pods 100 in the group of acquaintances 940 will change based on changing projections and when pods 920 go through a merge or fork. In all cases, the same sequence of handshakes will occur, such as notify current preceding and succeeding pods that they are leaving the group of acquaintances 940. In the notification mechanism, the pod 920 will send credentials of the preceding pod to the succeeding pod; and send credentials of the succeeding pod to the preceding pod. This operation will allow the current preceding and succeeding pods to register each other as succeeding and preceding pod of the other pod 100. Since each pod performs its own actions, these operations can be recursive to handle multiple pods leaving. The transfer of credentials also applies to the projected pods. As the projected time to reach a merge point increases or decreases, the pod computer 920 will hand off the projected pod credentials to the preceding and/or succeeding pod 100. The pods 100 will monitor the speed and distance of the preceding and succeeding pods and adjust its speed accordingly. Any changes in speed will be notified to the preceding and succeeding pods. Since each pod performs its own actions, these operations can be recursive.

Pod computer 920 instructs each sled 108 when to hold left side of track and when to hold right side. For most sections of track, the held side does not make a difference, but as a pod approaches a turnout 402, it will hold one side to correctly navigate through the turnout, i.e. stay on mainline track 302 or exit track 314. Standard operating procedure is to hold the left side until the pod will exit at the following turnout, at which time the right side will be held. A location marker in the track following each turnout will give positive location reference to the location detection module 986.

Operation is based on minimum time pod spacing. Pod speeds are controlled by pod computer 920 and are altered slightly to create gaps for merging pods. Standard minimum clear spacing between pods 100 will be 0.1 seconds, but can be decreased to near zero to increase capacity. At merge locations 313, mainline pods 921 will create a 0.5 second gap for new on-ramp pod 923 to fit in. Similarly, if closely spaced pods 923 are approaching on on-ramp, they will all have minimum 0.1 second spacing and can widen to 0.5 seconds if needed to fit around mainline pod 921. Standard capacity is approximately 7200 pods per hour per direction with an estimated best case maximum capacity in open conditions of approximately 60,000 pods per hour. Theoretical minimum spacing is based on time for single pod to traverse its own length at max speed, which is approximately 0.06 seconds. Minimum time spacing can be increased to create safety factor for pod to achieve correct location. Pods 100 traveling on mainline track 302, 303 can reduce space between each pod 100 to a near zero distance and form a single line, or train to reduce aerodynamic drag on following pods. Because the pod computer 920 has perfect information and communication with surrounding pod computers 920, all pods 100 can decelerate in perfect unison with no delay from reaction time. Turnouts 402 are based on full speed exits such that within a line of pods, there is no need to reduce speed for exiting pods to depart safely. Multiple wireless technologies to ensure highest level of security in both information received and encryption of information.

Location sensors 986 on tracks to create positive location for all pods. Command QA system 980 monitors performance history of pod 100 and of track section 302, 303 to minimize differences between directed and actual positioning of pods 100. Two independent communication systems are embedded in track corridor 300; one for pod communication as described, and a second user accessible system for Wireless Fidelity (Wi-Fi) access.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described with respect to certain preferred embodiments, but the invention is not limited only to the particular constructions disclosed and shown in the drawings as examples, and also comprises the subject matter and such reasonable modifications or equivalents as are encompassed within the scope of the appended claims.

What is claimed is:

1. An autonomous moving highway system, the system comprising:
an elevated guideway including:
a support pier having a top end and a bottom end opposite the top end;
a pier cap having a first end, a second end opposite the first end, an upper portion and a lower portion opposite the upper portion, the lower portion of the pier cap attached to the top end of the support pier;
a first girder located at the first end of the pier cap and a second girder located at the second end of the pier cap; and,
a first magnetically levitated (maglev) transportation track mounted to a bottom of the first girder and a second magnetically levitated (maglev) transportation track mounted to a bottom of the second girder,
a plurality of individual transportation pods; wherein each transportation pod is configured to enclose a vehicle and at least one passenger of the vehicle;
a computer control system, the computer control system configured to:
control power, propulsion, direction and motion of the plurality of transportation pods; and,
automatically guide one of the plurality of transportation pods to a destination selected by a user; and
a system station having a docking bay, the docking bay including a docking platform having a first end configured to receive the one of the plurality of transportation pod and a second end configured to receive the vehicle.

2. The system of claim 1, wherein the computer control system comprises a plurality of command modules within each transportation pod configured to:
control power, propulsion, direction and motion of the plurality of transportation pods in a region of the guideway; and,
automatically guide one of the plurality of transportation pods to a destination selected by a user.

3. The system of claim 1, further comprising a track continuity module configured to process track emergencies that are identified by a track continuity sensor.

4. The system of claim 1, further comprising an empty pod module configured to control flow of incoming and outgoing pods in the station and between stations.

5. The system of claim 1, further comprising a command quality assurance module configured to compare a directed position of the pod with an actual position of the pod.

6. The system of claim 1, further comprising a station manager module configured to control flow of incoming vehicles and incoming pods in the station.

7. The system of claim 1, further comprising a station docking module configured to control docking equipment located at the station.

8. The system of claim 1, further comprising a vehicle module configured to direct vehicles to pods docked in the station.

9. The system of claim 1, further comprising a vehicle database module configured to keep a log of all trips for a vehicle and to create a list of the top five destination for each pod based on day and time of entry.

10. The system of claim 1, further comprising a switch on the maglev transportation tracks; the switch having no moving parts.

11. The system of claim 1, further comprising a back-up trolley to maneuver the pod into the docking bay.

12. The system of claim 1, further comprising a dock magnet located at the first end of the docking platform.

13. The system of claim 1, further comprising a mobile phone application module to edit destination preferences.

14. The system of claim 1, wherein the transportation pod comprises:
a pod body configured to enclose a vehicle and at least one passenger of the vehicle;
a nose cone attached to a first end of the pod body and a pair of doors attached to a second end of the pod body that is opposite the first end of the pod body;
a maglev sled attached to a top of the pod body, the maglev sled configured to engage with a maglev transportation track of an autonomous moving highway system;
a front display and a side touchpad located in an interior of the pod body;
an air conditioner system and carbon monoxide detector; and,
a fail safe speed detector-emitter attached to a front surface of the maglev sled.

15. An individual transportation pod for us in an autonomous moving highway system, the transportation pod comprising:
a pod body configured to enclose a vehicle and at least one passenger of the vehicle;
a nose cone attached to a first end of the pod body and a pair of doors attached to a second end of the pod body that is opposite the first end of the pod body;
a maglev sled attached to a top of the pod body, the maglev sled configured to engage with a maglev transportation track of an autonomous moving highway system; and,
a fail safe speed detector-emitter attached to a front surface of the maglev sled.

16. The transportation pod of claim 15, further comprising:
an air conditioner system and carbon monoxide detector.

17. The transportation pod of claim 15, further comprising:
a front display and a side touchpad.

18. The transportation pod of claim 15, further comprising:
a headlight flash detector configured to detect hi-beam headlight flashes and a vehicle engine detector.

19. The transportation pod of claim 15, further comprising:
a front display panel configured to display information to a user of the transportation pod.

20. The transportation pod of claim 15, further comprising:
a dock stabilization magnet and a back-up trolley magnet.
